(19) United States
(12) Patent Application Publication
(10) Pub. No.: US 2014/0362277 A1
(43) Pub. Date: Dec. 11, 2014

(54) IMAGING APPARATUS AND CONTROL METHOD FOR SAME

(71) Applicant: CANON KABUSHIKI KAISHA, Tokyo (JP)

(72) Inventor: Takenori Kobuse, Kawasaki-shi (JP)

(73) Assignee: CANON KABUSHIKI KAISHA, Tokyo (JP)

(21) Appl. No.: 14/293,629

(22) Filed: Jun. 2, 2014

(30) Foreign Application Priority Data
Jun. 7, 2013 (JP) 2013-120374

(51) Int. Cl. H04N 5/232

(52) U.S. Cl. CPC H04N 5/23212
USPC 348/349

(57) ABSTRACT

An imaging apparatus includes an imaging element having pixel portions each having a plurality of photoelectric conversion units for each microlens. The imaging element can output a pixel signal depending on a pupil-divided light flux. An image processing LSI processes a video signal based on the pixel signal output from the imaging element. An imaging element control unit controls the operation of the imaging element. An exposure control unit performs exposure control for an optical lens unit and an imaging element. In the first mode, the operation for reading pixel signals from all of the plurality of photoelectric conversion units constituting the pixel portion of the imaging element is performed. In the second mode, the control for reading pixel signals from a part of the plurality of photoelectric conversion units and for stopping a circuit relating to the unused photoelectric conversion units by reading no pixel signal is performed.

### BACKGROUND OF THE INVENTION

1. Field of the Invention

The present invention relates to an imaging apparatus such as a digital single-lens reflex camera, a digital still camera, a digital video camera, or the like and a control method for the same.

2. Description of the Related Art

Conventionally, as a focus position detecting method executed by an imaging apparatus, there have been known a method for inserting light into a sensor dedicated for auto focus (AF) using a mirror and a phase difference detecting method using a sensor for detecting a focus state. There has also been known a contrast detecting method for focusing by searching a position having a large difference in brightness (contrast) while moving a focus lens based on a video signal obtained by an imaging element. In the phase difference detecting method using a sensor dedicated for AF, accurate focusing can be ensured, whereas the number of parts increases, resulting in an increase in size of the apparatus and an increase in costs. In addition, in the contrast detecting method, the time required for focusing is longer than that as compared with the phase difference detecting method.

Thus, in order to obtain the advantages of both methods, there has recently been proposed an imaging plane phase difference detecting method. In the method, a pixel for detecting a phase difference is provided in an imaging element which captures light from an imaging lens and then converts the light into a video signal. Japanese Patent Laid-Open No. H4-267211 discloses an imaging apparatus having a pair of pixels each of which receives a light flux from an object, which has been passed through a pair of pupil portions (e.g., regions on the left side and the right side) in the exit pupil of an image-taking lens (image-taking optical system), so as to be able to generate a signal for phase difference detection.

However, in the imaging apparatus disclosed in Japanese Patent Laid-Open No. H4-267211, power consumption of the imaging element and power consumption of image processing performed by the imaging apparatus undesirably increase with an increase in the number of pixels in the imaging element.

### SUMMARY OF THE INVENTION

The present invention provides an imaging apparatus including an imaging element capable of performing pupil division-type phase difference focus detection so as to reduce power consumption while suppressing degradation in image quality.

According to an aspect of the present invention, an imaging apparatus that performs focus adjustment control by pupil division-type phase difference focus detection is provided that includes an imaging element configured to output a pixel signal from a pixel portion having a plurality of photoelectric conversion units for each microlens; an image processing unit configured to process a pixel signal output from the imaging element; and a control unit configured to control reading of a pixel signal from the imaging element and image processing performed by the image processing unit. The control unit has a first mode for reading pixel signals from all of the plurality of photoelectric conversion units constituting the pixel portion and a second mode for reading pixel signals from a part of the plurality of photoelectric conversion units and controls to stop a circuit relating to the photoelectric conversion units from which no pixel signal is read in the second mode.

According to the present invention, an imaging apparatus including an imaging element capable of performing pupil division-type phase difference focus detection so as to reduce power consumption while suppressing degradation in image quality may be provided.

Further features of the present invention will become apparent from the following description of exemplary embodiments with reference to the attached drawings.

### BRIEF DESCRIPTION OF THE DRAWINGS

FIG. 1 is a diagram illustrating an exemplary configuration of an imaging apparatus according to an embodiment of the present invention.

FIGS. 2A to 2D are diagrams illustrating examples of a configuration of an imaging element according to an embodiment of the present invention.

FIGS. 3A and 3B are flowcharts illustrating operations according to an embodiment of the present invention.

FIGS. 4A to 4D are exemplary illustrations of waveform monitor according to an embodiment of the present invention.

### DESCRIPTION OF THE EMBODIMENTS

Hereinafter, preferred embodiments of the present invention will be described with reference to the drawings.

### First Embodiment

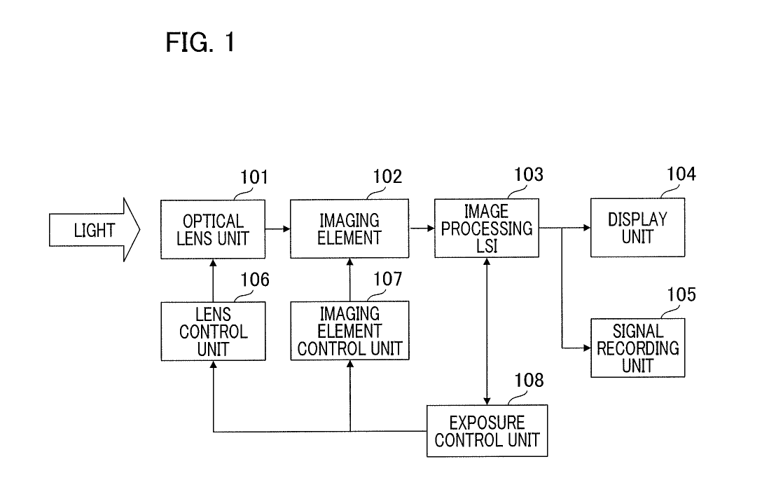

FIG. 1 is a block diagram illustrating a general configuration of an imaging apparatus according to a first embodiment of the present invention. An optical lens unit 101 constituting an imaging optical system captures light from an object and images the captured light onto the light receiving plane of an imaging element 102. The optical lens unit 101 includes a focus lens, an aperture, a zoom lens for changing a focal length, and the like. The imaging element 102 converts light captured from the optical lens unit 101 into an electrical signal by photoelectric conversion. An image processing LSI (large scale integrated circuit) 103 is an image processing unit configured to process a video signal output from the imaging element 102. When the imaging element 102 output an analog signal, the image processing LSI 103 converts the analog signal into a digital signal. Also, the image processing LSI 103 performs various types of image processing, such as digital gain, gamma correction, and knee correction, for a digitized video signal, and then performs processing for clamping the video signal by measuring a black level in the output signal from the imaging element 102 and the like. A display unit 104 displays an image in accordance with a video signal such as a moving image digital-processed by the image processing LSI 103. A signal recording unit 105 performs processing for recording a video signal on a recording medium.

A lens control unit 106 controls focus adjustment, an aperture value, a focal length, and the like for the optical lens unit 101. An imaging element control unit 107 controls an imaging operation by outputting a drive signal to the imaging element 102. An exposure control unit 108 determines the exposure time for the imaging element 102, and outputs a control signal for use in exposure control to the lens control unit 106 and the imaging element control unit 107. Note that the respective block elements shown in FIG. 1 are not limited to divided LSIs but may also be constituted by an LSI in which a plurality of blocks are integrated or an LSI in which the entire blocks are integrated. For example, the respective block elements may also be configured by a circuit unit such that the lens control unit 106, the imaging element control unit 107, the exposure control unit 108, and the like are provided in one system control unit.

Hereinafter, a description will be given of the details of the respective units. The optical lens unit 101 has a focus mechanism for focusing, an aperture mechanism for adjusting the amount of light or the depth of field, and a zoom mechanism for changing a focal length. It should be noted that no zoom mechanism is prepared in the case of a single focus lens and no focus mechanism is prepared in the case of a pan-focus lens because there is only one focus position at infinity. In order to reduce the costs of the lens, the aperture mechanism may also be substituted for an ND filter for adjusting the amount of light at one aperture position. The optical lens unit 101 includes all forms of constitution for receiving light by imaging the light onto the imaging element 102.

The imaging element 102 is a CCD (Charge-Coupled Device) image sensor, a CMOS (complementary metal-oxide semiconductor) image sensor, or the like, which is capable of reading and outputting a pixel signal from a pixel portion in any column or row on an image-taking screen. The imaging element 102 is classified into a type in which an analog video signal is directly output or a type in which digital data by LVDS is output by performing AD (Analog to Digital) conversion processing within the imaging element 102, where LVDS is an abbreviation for “Low Voltage Differential Signaling”.

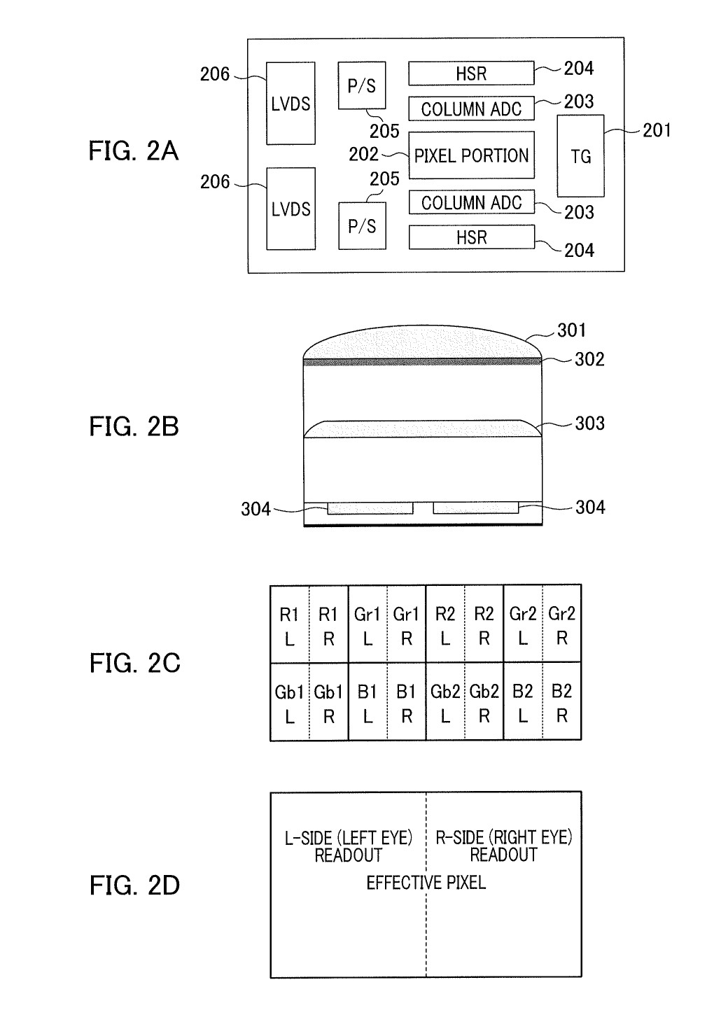

FIG. 2A shows an exemplary configuration of the imaging element 102. A TG unit 201 is a timing generator that controls driving of the entire imaging element. A pixel portion 202 has a photodiode for converting light into an electrical signal and a floating diffusion amplifier, and transmits pixels to a column ADC unit 203 provided downstream of the pixel portion 202 on a column-to-column basis. The column ADC unit 203 performs AD conversion to digitize the level of analog video signals of pixels output from the pixel portion 202. A HSR (horizontal shift resistor) unit 204 is a circuit that transfers digital signals of pixels from the column ADC unit 203 to a P/S (parallel/serial conversion) unit 205 on a row-to-row basis. The P/S unit 205 is a circuit that converts a digital signal into an LVDS output which has recently been used as an output method. A LVDS unit 206 is a drive circuit that outputs a serial signal converted by the P/S unit 205.

A description will be given of the pixel portion 202 with reference to the cross-sectional schematic diagram shown in FIG. 2B. A microlens 301 is an optical element that efficiently injects light irradiated onto the imaging element into a photodiode (hereinafter referred to as “PD”) 304. The microlens 301 can increase sensitivity of the imaging element by increasing a condensation rate of light. A color filter 302 is an optical element that splits incident light into its three colors, e.g., R (Red) color, G (Green) color, B (Blue) color or into its four colors. An exemplary structure of the color filter 302 includes Bayer array. An inner lens 303 may also be referred to as an “interlayer lens” which is disposed between the microlens 301 and the PD 304. The introduction of the inner lens 303 may not only be effective for reducing pixels but also improve sensitivity to a light beam having a strict incident angle with a small aperture F-number.

The PD 304 is a photoelectric conversion unit that converts incident light into electrons. In the imaging apparatus of the present invention, each pixel portion has two or more PDs (this structure is referred to as a “pupil division structure”). Specifically, a circuit for reading a plurality of signals is provided for one microlens 301. This is one approach for realizing the imaging plane phase difference detecting method. Video signals read from a plurality of PDs are compared so that a phase difference can be detected by correlation calculation.

FIG. 2C is a schematic diagram illustrating pupil division-type pixels as viewed from the top of the imaging element. In the present invention, a pixel portion constituting an imaging element in a Bayer array is divided into two parts in the left and right direction. For example, there are two pixels, i.e., R1L and R1R, for an R pixel. The symbols R, Gr, Gb, and B represent different colors, and the symbols L and R designated immediately thereunder represent different pixels for a left-eye and a right-eye. Hereinafter, the term “one eye” is used when there is only L or only R, i.e., when there is either one of L and R, whereas the term “both eyes” is used when both L and R are combined. For example, a PD in which R is added to each of R1 and Gb1 is intended for one eye, and PDs in which L and R are added to B1 are intended for both eyes. Hereinafter, the first mode for reading pixel signals from all of a plurality of photoelectric conversion units constituting each pixel portion is referred to as a “both-eyes pixel read mode”. The second mode for reading pixel signals from a part of the plurality of photoelectric conversion units constituting each pixel portion is referred to as a “one-eye pixel read mode”. In the second mode, the control for stopping a circuit relating to the photoelectric conversion units from which no pixel signal is read is performed. In other words, when a signal is read from either one of two PDs constituting each pixel portion, power consumption of a circuit unit from which no signal is read can be reduced. For example, this applies to the case where a signal is read from the pixel R1L and no signal is read from the pixel R1R. A vertical reading line circuit and a circuit such as a column ADC of a pixel portion are not used for pixels from which no signal is read, resulting in a reduction in power consumption.

The image processing LSI 103 shown in FIG. 1 is constituted by an analog front end (AFE) unit that converts an analog electrical signal output from the imaging element 102 into a digital signal and a block that processes a digitized video signal. When the imaging element 102 outputs a digital signal by LVDS or the like by performing AD conversion within the imaging element 102, the AFE unit is omitted. When the imaging element 102 is a CMOS image sensor, the image processing LSI 103 performs removal of a fixed pattern noise specific to the CMOS image sensor, black level clamp processing, or the like. Examples of representative image processing functions of the imaging apparatus include a pixel data summing function, noise reduction, gamma correction, knee correction, digital gain control, flaw correction, and the like. The image processing LSI 103 includes a storage circuit that stores set values required for correction and image processing. The image processing LSI 103 measures the input video signal, and then outputs current exposure information to the exposure control unit 108.

The exposure control unit 108 acquires exposure information from the image processing LSI 103, and then executes calculation required for control for adjusting the imaging apparatus in an optimum exposure state based on the information. When a lens control instruction is received by a user's operation, the exposure control unit 108 transmits a control command by determining the operation of the lens control unit 106 for controlling driving of the optical lens unit 101 and the operation of the imaging element control unit 107.

The display unit 104 includes a monitor device, a liquid crystal monitor and a view finder to be attached to an imaging apparatus, and the like. The user of the imaging apparatus can check the angle of view, exposure, and the like by looking an image displayed on the display unit 104. A video signal, to which image processing has been reflected, from the image processing LSI 103 is input to the signal recording unit 105, and then the signal recording unit 105 performs processing for recording a signal in a recording medium or a storage device (not shown).

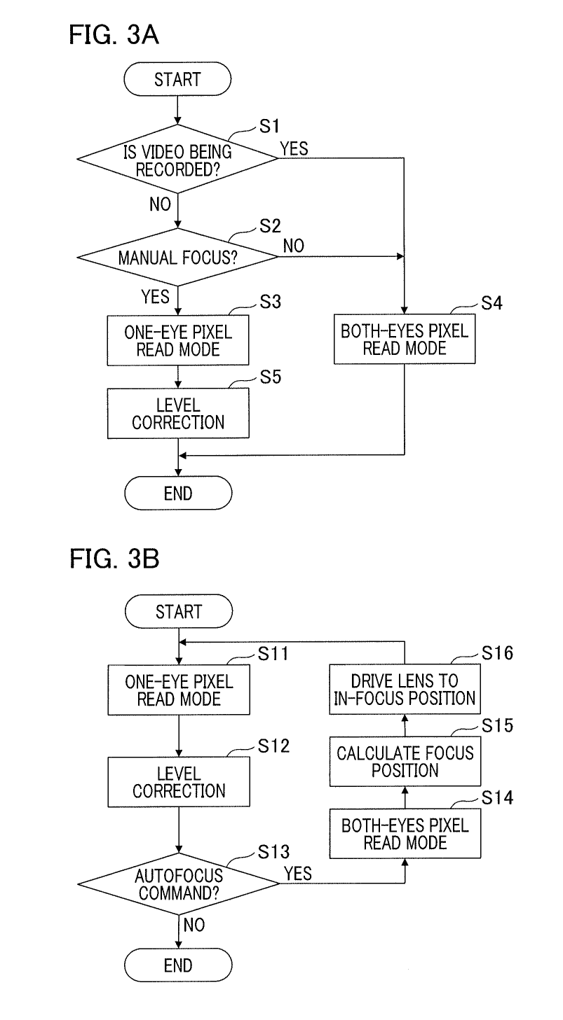

Next, a description will be given of exposure control and driving of the imaging element of the imaging apparatus of the present invention with reference to the flowchart exemplified in FIG. 3A. The following processing is implemented by the CPU (Central Processing Unit) constituting the control unit of the imaging apparatus by reading and executing a control program from a memory and controlling the respective units.

In step S1, the imaging apparatus determines whether the signal recording unit 105 is recording a video signal or the video signal is not being recorded by the signal recording unit 105 but is in the preview mode. If the signal recording unit 105 is recording a video signal, the process advances to step S4. If not, the process advances to step S2. In step S4, the imaging element control unit 107 is set to the both-eyes pixel read mode in order to record a video signal without degradation in image quality. In the both-eyes pixel read mode, PD signals are read from both L (left-eye) and R (right-eye) pixels as described in FIGS. 2A to 2D.

In step S2, the imaging apparatus determines whether or not the current mode is a manual focus mode. If the current mode is the manual focus mode where the user performs focus adjustment by a manual operation as a result of determination, the process advances to step S3, whereas if the current mode is not the manual focus mode, the process advances to step S4. If the current mode is not the manual focus mode, i.e., if auto focus control is performed by the imaging plane phase difference detecting method, power consumption cannot be saved by the setting of the one-eye pixel read mode. In step S3, the imaging element control unit 107 is set to the one-eye pixel read mode. In the one-eye pixel read mode, a PD signal is read from either L (left-eye) or R (right-eye) pixel as described in FIGS. 2A to 2D. When a video signal is generated based on either one of the pixel signals, nonuniform brightness distribution due to the occurrence of parallax needs to be taken into consideration.

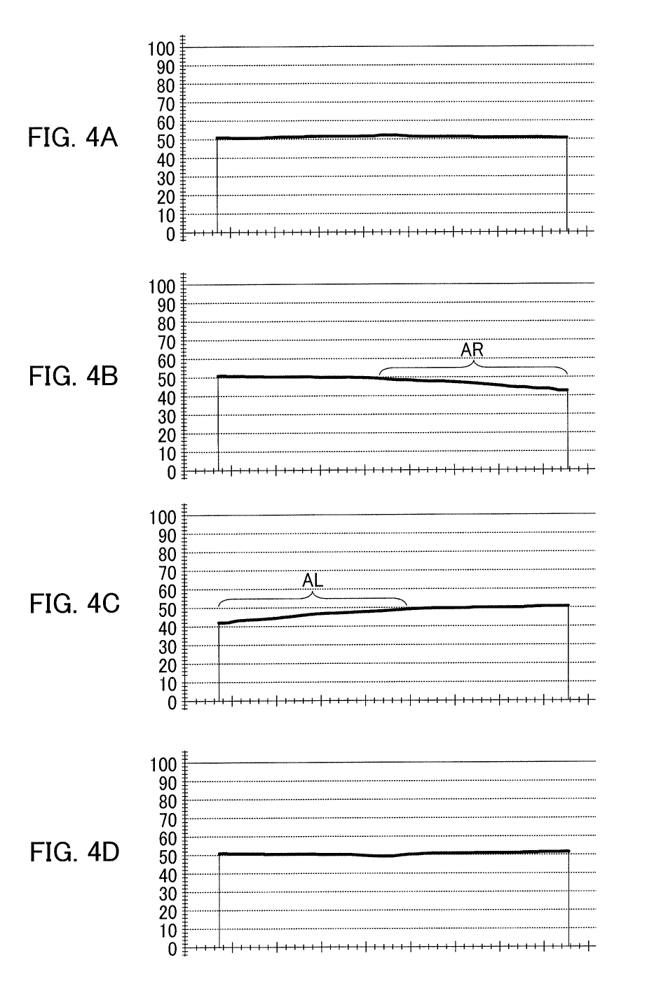

Each of FIGS. 4A to 4D illustrates the behavior of a video signal when a surface having a uniform irradiance is captured. Each of FIGS. 4A to 4D shows an example in which a video signal from an imaging apparatus is input to an external waveform monitor so as to measure a video signal in the horizontal direction. The vertical axis indicates a signal level in any unit and the horizontal axis indicates the position of a video signal in the horizontal direction.

FIG. 4A illustrates the level of a video signal generated by both outputs of the L pixel and the R pixel in the both-eyes pixel read mode. A video signal which is uniform in the horizontal direction is obtained. In contrast, FIG. 4B illustrates the level of a video signal generated by only the output of the L pixel and FIG. 4C illustrates the level of a video signal generated by only the output of the R pixel. In FIGS. 4B and 4C, the level of a video signal is varied as compared with FIG. 4A. It can be seen that the level of a video signal decreases in the right side part AR shown in FIG. 4B and in the left side part AL shown in FIG. 4C, and thus, shading occurs in brightness and color distribution.

Thus, in step S5 in FIG. 3A, the image processing LSI 103 executes level correction processing for a video signal. More specifically, the image processing LSI 103 multiplies a portion at which the video level is attenuated due to shading, i.e., the right side part AR on the screen in FIG. 4B and the left side part AL on the screen in FIG. 4C, by a digital gain (multiplication of correction gain). The uniformity of the video signal can be recovered by the level correction processing as shown in FIG. 4A.

According to the present embodiment, an imaging apparatus that performs focus adjustment control by pupil division-type phase difference focus detection so as to reduce power consumption while suppressing degradation in image quality may be provided. Specifically, power consumption of the imaging element and the imaging apparatus can be saved by the setting of the second mode (the one-eye pixel read mode). For shading which may arise in this case, level correction for a video signal is performed, so that video which does not cause uncomfortable feeling can be provided to a user.

A feature of the present embodiment lies in the structure and control of the imaging element and the image processing unit. For example, the present invention is applicable to various types of imaging elements which are capable of reading pixel signals from a plurality of photoelectric conversion units constituting a pixel portion in any column or row on an image-taking screen and outputting the pixel signals. In this case, when the control unit is set to the second mode, the control unit controls to stop the circuits relating to the photoelectric conversion units, which are arranged in the column or row from which no pixel signal is read, from among a plurality of photoelectric conversion units constituting a pixel portion. In the second mode, the control unit performs level correction processing for video signals generated from pixel signals output from the photoelectric conversion units constituting the pixel portion in the column or row from which the pixel signals have been read.

The present invention is not limited to the present embodiment but may also be applicable to the case where no column ADC is provided in the structure of the imaging element, the case where the pixel structure is backside illuminated type, and the case where the MOS-type image sensor is mounted on the imaging apparatus. The present invention is also applicable to a meteorological observation camera, a monitoring camera, and the like in which no display unit or no signal recording unit is provided to the configuration of the imaging apparatus.

### Second Embodiment

Next, a description will be given of a second embodiment of the present invention. In the present embodiment, the same reference numerals already used are used for the same components as those in the first embodiment, and thus, a detailed description thereof will be omitted. A description will be given of the differences from the first embodiment. Likewise, a description will be omitted in the same manner in other embodiments to be described below.

In the first embodiment, countermeasure against shading is taken by level correction while reducing power consumption. In this case, for example, in a video signal generated from the L pixel only, a digital gain is multiplied on the right side of the screen, so that the noise in the video signal may increase toward the right side of the screen. Thus, in the present embodiment, pixels to be read out are switched in a column in the center of the imaging screen. FIG. 2D illustrates the range of effective pixels corresponding to the imaging screen. In the range of the left side from the center of the screen having effective pixels, L-side pixels are read, that is, the output from the left-eye pixels is read. On the other hand, in the range of the right side from the center of the screen having effective pixels, R-side pixels are read, that is, the output from the right-eye pixels is read. Pixel selection control is performed by the imaging element control unit 107. By reading pixel signals while switching them, the output of video signals from the imaging apparatus is as shown in FIG. 4D when a surface having a uniform irradiance is captured. In FIG. 4B, the level distribution of the left side part excluding the right side part AR of the screen is uniform, whereas in FIG. 4C, the level distribution of the right side part excluding the left side part AL of the screen is uniform. Thus, one eye pixel to be read out is switched (from the L pixel to the R pixel) relative to the center of the screen having effective pixels, so that the uniformity of the video signal can be ensured. In order to obtain a signal having a uniform distribution as shown in FIG. 4A, the pixel output corresponding to the central portion of the screen needs to be corrected by multiplying a digital gain thereto, but the amount of correction gain is small as compared with the first embodiment.

In video for which switching is performed in a column in the center of the screen, there is no parallax if the object at the central portion of the screen is in focus, the boundary portion does not stand out in the user's eyes. If the central portion of the screen is out of focus, deviation of video may remain due to the presence of parallax. However, since the focus is not adjusted to the position at the central portion of the screen, the main object is not present at the position. Thus, the user is unaffected by deviation of video at the boundary.

The control for switching pixels to be read out at the center of the screen is generalized by changing a column from which pixels are to be read out to any column. In other words, the imaging element control unit 107 has a function that switches pixels to be read out in any column of the imaging element 102, and executes processing for moving a column at which pixels to be read out are switched to a position which is in focus on the screen. In this manner, video in which the occurrence of deviation at the boundary is suppressed to minimum can be present to the user.

According to the present embodiment, when the control unit is set to the second mode, the control unit controls to switch a pixel from which a pixel signal is to be read out from a left-eye pixel to a right-eye pixel or from a right-eye pixel to a left-eye pixel in the center of the imaging screen or in any column. In this manner, power consumption can be saved while suppressing the occurrence of noise originating from level correction for a video signal as the countermeasure against shading.

### Third Embodiment

Next, a description will be given of a third embodiment of the present invention. In the present embodiment, a description will be given of an imaging apparatus which can save power consumption while performing an AF operation using the imaging plane phase difference detecting method. A description will be given of the AF operation according to the present embodiment with reference to the flowchart shown in FIG. 3B. Steps S11 and S12 are the same as steps S3 and S5 shown in FIG. 3A. Thus, a description will be mainly given of steps S13 to S16.

During a normal preview mode upon shooting, the one-eye pixel read mode is set in step S11 and level correction is performed in step S12. In step S13, determination processing is performed for determining whether or not an AF command is given by a user's operation instruction or whether or not the imaging apparatus itself changes its focus state. The CPU performs determination processing. If the AF operation is performed, the process advances to step S14. If no AF operation is performed, the process ends.

In step S14, the imaging element control unit 107 is set to the both-eyes pixel read mode so as to control to read data from the L pixel and the R pixel. In step S15, the CPU calculates an in-focus position using the imaging plane phase difference detecting method based on pixel data read in step S14. In other words, the amount of image deviation is calculated by correlation calculation of two image signals obtained by pupil division. The process advances to step S16, and the lens control unit 106 controls to move a focus lens to an in-focus position in accordance with the amount of defocus determined by the amount of image deviation calculated in step S15. Then, the process returns to step S11.

In the present embodiment, the setting is changed to the both-eyes pixel read mode when an in-focus position is calculated by focus adjustment control. The one-eye pixel read mode is set in other states (including the preview state), so that the power consumption of the imaging apparatus can be saved.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-120374, filed on Jun. 7, 2013, which is hereby incorporated by reference herein in its entirety.

What is claimed is:

1. An imaging apparatus that performs focus adjustment control by pupil division-type phase difference focus detection, the imaging apparatus comprising:
an imaging element configured to output a pixel signal from a pixel portion having a plurality of photoelectric conversion units for each microlens;
an image processing unit configured to process the pixel signal output from the imaging element; and
a control unit configured to control reading of the pixel signal from the imaging element and image processing performed by the image processing unit,
wherein the control unit has a first mode for reading pixel signals from all of the plurality of photoelectric conversion units constituting the pixel portion and a second mode for reading pixel signals from a part of the plurality of photoelectric conversion units and controls to stop a circuit relating to the photoelectric conversion units from which no pixel signal is read in the second mode.

2. The imaging apparatus according to claim 1, wherein, when the image processing unit generates video signals from pixel signals which are read from a part of the plurality of photoelectric conversion units in the second mode, the control unit controls level correction of the video signals.

3. The imaging apparatus according to claim 2, wherein the imaging element is capable of reading pixel signals from the plurality of photoelectric conversion units constituting the pixel portion in any column or row on an image-taking screen and outputting the pixel signals, and the control unit stops a circuit relating to the photoelectric conversion units constituting the pixel portion in the column or row from which no pixel signal is read in the second mode and controls the level correction of video signals generated from pixel signals output from the photoelectric conversion units constituting the pixel portion in the column or row from which the pixel signals have been read in the second mode.

4. The imaging apparatus according to claim 1, further comprising:
a signal recording unit configured to record a video signal generated by the image processing unit,
wherein the control unit is set to the first mode when the video signal is recorded by the signal recording unit, whereas the control unit is set to the second mode when the video signal is not recorded by the signal recording unit.

5. The imaging apparatus according to claim 1, wherein the pixel portion of the imaging element has a photoelectric conversion unit configured to output a left-eye pixel signal and a photoelectric conversion unit configured to output a right-eye pixel signal, and the control unit controls to read a pixel signal from the photoelectric conversion unit configured to output a left-eye pixel signal or a right-eye pixel signal in the second mode.

6. The imaging apparatus according to claim 1, wherein the pixel portion of the imaging element has a photoelectric conversion unit configured to output a left-eye pixel signal and a photoelectric conversion unit configured to output a right-eye pixel signal, and, when the control unit is set to the second mode, the control unit controls to switch a pixel, from which a pixel signal is read, in any column on an imaging screen from the left-eye pixel to the right-eye pixel or from the right-eye pixel to the left-eye pixel.

7. The imaging apparatus according to claim 1, wherein the pixel portion of the imaging element has a photoelectric conversion unit configured to output a left-eye pixel signal and a photoelectric conversion unit configured to output a right-eye pixel signal, and, when the control unit is set to the second mode, the control unit controls to read a pixel signal from the left-eye pixel in the range on the left side of an imaging screen and to read a pixel signal from the right-eye pixel in the range on the right side of the imaging screen by switching pixels to be read out in the center of the imaging screen.

8. The imaging apparatus according to claim 1, wherein, when the control unit performs auto focus control by a phase difference detecting method using a pixel signal output from the imaging element, the control unit is set to the first mode.

9. The imaging apparatus according to claim 8, wherein, in the case of the manual focus mode, the control unit is set to the second mode.

10. A control method to be executed by an imaging apparatus that performs focus adjustment control by pupil division-type phase difference focus detection and includes an imaging element configured to output a pixel signal from a pixel portion having a plurality of photoelectric conversion units for each microlens; an image processing unit configured to process the pixel signal output from the imaging element; and a control unit configured to control reading of the pixel signal from the imaging element and image processing performed by the image processing unit, the method comprising:
reading, by the control unit, pixel signals from all of the plurality of photoelectric conversion units constituting the pixel portion in a first mode;
reading, by the control unit, pixel signals from a part of the plurality of photoelectric conversion units in a second mode and controlling to stop a circuit relating to the photoelectric conversion units from which no pixel signal is read in the second mode.
